(19) United States
(12) Patent Application Publication
(10) Pub. No.: US 2005/0198124 A1
(43) Pub. Date: Sep. 8, 2005

(54) System and method for embedded instant messaging collaboration

(76) Inventor: Shawn Jimmy McCarthy, Fort Worth, TX (US)

Correspondence Address: RUBEN C. DELEON;WINSTEAD SECHROST & MINICK P.C., P.O. BOX 50784, DALLAS, TX, 75201, US

(21) Appl. No.: 11/067,334

(22) Filed: Feb. 25, 2005

Related U.S. Application Data
(60) Provisional application No. 60/549,824, filed on Mar. 3, 2004.

(51) Int. Cl. G06F 15/16

(52) U.S. Cl. 709/203; 709/206

(57) ABSTRACT

The present invention provides a method, apparatus and system for implementing and managing a messaging-collaboration tool embedded in a website page or email message. The invention enables users of the Worldwide Web to interactively chat online, capture messages and write the transcripts to a relational database. Uses of the data include prolonged communications, queries, analysis, user tracking, manipulations and exporting to other databases. Users chat in a real-time or near real-time mode, on a constantly open connection, via a host server that transmits, receives, and archives a plurality of transcripts. Using the database schema or web service, the transcripts are readily exportable to target applications.

### CROSS-REFERENCE TO RELATED APPLICATIONS

This application claims priority to U.S. Provisional Application Ser. No. 60/549,824, entitled “Instant Messaging-Collaboration System and Method”, by McCarthy, filed Mar. 3, 2004.

### FIELD OF THE INVENTION

The present application is related to capturing electronic data for storage in a relational database and more particularly to capturing and storing collaborative conversations communicated via an instant messaging service embedded within a client interface.

### BACKGROUND

The Internet or Worldwide Web (“Web”) is a vehicle for doing business, research and generally enhancing personal lifestyles. As the Internet grows, Electronic Commerce (“e-commerce”) expands, which encompasses many business-to-business, business-to-consumer and consumer-to-consumer Web sites. Communications is the common thread for all scenarios, and there exists a need for improvement. Although electronic mail communication is considerably faster than regular mail, the instant acknowledgement of phone conversations or face-to-face conversations is highly desirable. To meet this need, Instant Messaging (IM); or as it is commonly known, “chatting”, has proliferated the Internet over the last few years. Instant Messaging allows users to almost instantly view and respond to the communications of another. Service providers make this possible through chat tools using a front-end design approach, such as MSN Messenger by Microsoft Corporation and Yahoo messenger by Yahoo Inc.

“Chatting” is simply defined as the real-time exchange of textual input by users simultaneously connected to the Internet. In other terms, chatting is the broadcast, multicast, or unicast of messages posted by users connected to the same server on the Internet. Users may be connected by any number of different client programs, browsers, or Internet Service Providers (“ISPs”). A single Internet site, the host chat provider, serves as a common facilitator for messages between chat conversants. Chats are generally impromptu conversations, but may be scheduled according to the host chat provider's business rules.

Generally, most chat systems are hosted by service providers, for example MSN or America Online, or by specialized Web sites, wherein some Web sites have the sole purpose of conducting chats. Chat programs are largely constructed having a protocol called “Internet Relay Chat” (IRC), which is a public domain software body that was first released in May 1993. IRC facilitates client-server handshaking, and client-server and client-client interchange sessions. A chat session can also include the use of sound and graphics with the appropriate programming.

Almost anyone around the globe can access the Internet, send electronic mail, fill out Web forms, or communicate via Instant Messaging. Users can access the Web twenty-four hours a day, seven days a week, but cannot transmit messages to a host site at will. Online messaging products available on the market today are largely transient and only provide random interactive operations. In other words, messages are not effectively and successfully transmitted to a person if a recipient is not signed onto a provider's host computer.

On any given day, billions of information bytes are transmitted across the Internet. Some of this data is captured through email systems, Web forms and specialized Electron Data Interchange (EDI) programs. This represents only a small portion of the total data transmitted. In the twenty-first century, online chatting continues to emerge as a mainstream method of ad hoc communications. In keeping pace, there are a growing number of dedicated chat sites such as Alamak Chat, CoolChat, Delphi Forums, em9, The Third Voice, Tribal Voice PowWow, VillageIRC and Zhongwen.com. Unfortunately, an enormous amount of chat data is never captured when using most available conventional chat systems. Therefore, millions of messages are wasted in cyberspace daily, or at best, manually deposited in a static word processor or “flat” file.

Therefore, there exists a need for an improvement in the ability to systematically identify, store and manipulate the content and identification data of a chat that would be beneficial to users. In addition, there exists a need to provide the ability to simplify the connectability of users to promote instant messaging.

### SUMMARY

The present invention and embodiments thereof can typically be viewed as providing a method, apparatus and system for implementing and managing a messaging-collaboration tool embedded in website pages or email messages. The invention enables users of the Web to interactively chat online using several channels, capture messages and write transcripts to a relational database. Uses of the data include prolonged communications, queries, analysis, user tracking, auditing, and manipulations and exporting to other databases. Users chat in a real-time or near real-time mode, on a constantly open connection, via a host server that transmits, receives, and archives a plurality of transcripts. Using the database schema and web service, the transcripts are readily exportable to target applications.

It is one objective of the present invention to provide a universal messaging/chat system that is compatible with the Worldwide Web. The messaging system of the present invention is built on open internet standards such as, but not limited to, HTML, XML, Web Services, and HTTP (port 80). The present invention utilizes XML over HTTP protocol for data transport and packaging of messages. Such application allows the architecture to be loosely coupled and provides extensive interoperability. The system facilitates an open forum method of collaborative communications, with or without, the typical constraints of user identification (“Ids”), log-ins, special software controls or equipment by using open standards such as, but not limited to, Web Services and XML.

It is another object of the present invention to provide host websites (for example, eBay) a means to reduce necessity and frequency of emails between customers and minimize the chance of outside communication by utilizing the present invention's auction specific embedded message board system to streamline the communication process synchronously or asynchronously.

It should be understood that anyone of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

### BRIEF DESCRIPTION OF THE DRAWINGS

Many of the aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. The invention may take physical form in certain parts and arrangement of parts. A preferred embodiment of these parts will be described in detail in the specification and illustrated in the accompanying drawings, which forms a part of this disclosure. For a more complete understanding of the present invention, and the advantages thereof, reference is now made to the following descriptions taken in conjunction with the accompanying drawings, in which:

FIG. 1 is a high-level network overview of the system of the present invention for instant messaging collaboration communication over a network according to the present invention;

FIG. 2 is an overview of an embodiment of the present invention providing for specific website-wide embedded chat box collaboration for multiple users for their listings according to the present invention;

FIG. 3 is an overview of an embodiment of the present invention allowing a user to have embedded user-specific chat boxes for collaboration for their specific listings according to the present invention;

FIG. 4 is an overview of an embodiment of the present invention allowing a user to have embedded listing/item/service specific chat boxes for collaboration according to the present invention;

FIG. 5 is an overview of an embodiment of the present invention embedded in a web market/fixed price or auction site according to the present invention;

FIG. 6 is an overview of an embodiment of the present invention embedded in an email message according to the present invention;

FIG. 7 depicts when a chat box of the present invention is embedded in an email message that is forwarded to multiple email recipients according to the present invention; and,

FIG. 8 is a flow diagram according to one embodiment of the present invention.

### DETAILED DESCRIPTION

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein. The Detailed Description to follow provides an overview of the system and method and provides discussion of the elements within the accompanying Figures.

To maintain consistency throughout the application, the following terms are defined:

Web browser—refers to any software program that displays text, graphics, or both, from Web pages on Worldwide Web sites.

Web page—refers to any document written in a mark-up language including, but not limited to, HTML (Hypertext Mark-up Language) or XML (Extensible Markup Language), JAVA, Active Server Pages or related computer languages thereof, as well as to any collection of such documents reachable through one specific Internet address or at one specific Worldwide Web site, or any document obtainable through a particular URL (Universal Resource Locator).

Display a Web page—refers to all actions necessary to render at least a portion of the information on the Web page available to the computer user. As such, the phrase includes, but is not limited to, the static visual display of static graphical information, the audible production of audio information, the animated visual display of animation and the visual display of video stream data.

Web site—refers to at least one Web page, and/or a plurality of Web pages, virtually connected to form a coherent group.

Applet—refers to a self-contained software module written in an applet language such as Java or constructed as an ActiveX control.

Network—refers to a connection between any two or more computers permitting the transmission of data including, but not limited to, the Internet.

Computer—refers to, but is not limited to, personal computers (PCs), laptops, PDAs, and computer tablets etc. having an operating system such as DOS, Windows, OS/2, or Linux, Macintosh, computers; computers having JAVA, OS as the operating system; and graphical workstations such as the computers of Sun Microsystems, and Silicon Graphics, and other computers having some version of the UNIX operating system such as AIX or SOLARIS, of Sun Microsystems or any other known and available operating system.

Windows—refers to, but is not limited to Windows95, Windows 3.x. in which “x” is an integer such as “1”, Windows NT, Windows98. Windows CE, and any upgraded versions of these operating systems by Microsoft Inc.

Mighty Collaboration System (MC)—(hereinafter “MC” or “system” or “MC system”)—refers to the present invention system and components and how they relate to and communicate with multiple types of industry and various applications in a network universe via embedded coded chat boxes whether on a website or in an email message, or the like.

Embedded in email message—refers to the rendering of the same chat that is referenced in a Web page, but can be viewed in an email message without opening a website to respond to messages.

User—refers to the person who operates the Web browser, the present invention's chat box or page, or other GUI interfaces that assist in the navigation of system invention.

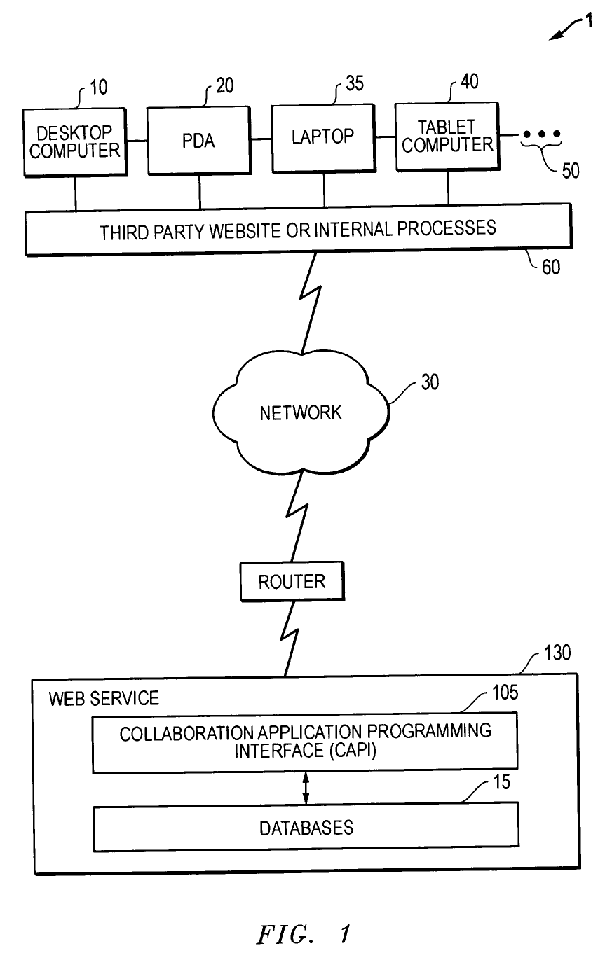

Referring now to the Figures, FIG. 1 depicts a universal messaging/chat system 1 according to the present invention is shown. The system of the present invention comprises a universal messaging/chat system (“MC”) 1 that is compatible with a network 30 including, but not limited to the Internet and the pervasive Worldwide Web. The messaging system 1 of the present invention is built on open internet standards such as, but not limited to, HTML, XML, Web Services, and HTTP (port 80). The present invention utilizes XML over HTTP protocol for data transport and packaging of messages. Such application allows the architecture to be loosely coupled and provides extensive interoperability.

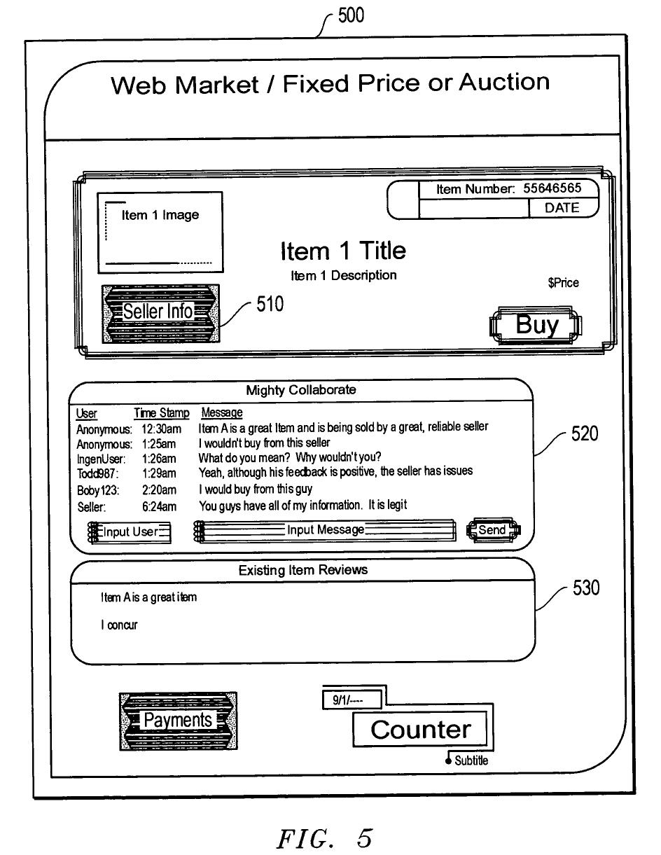

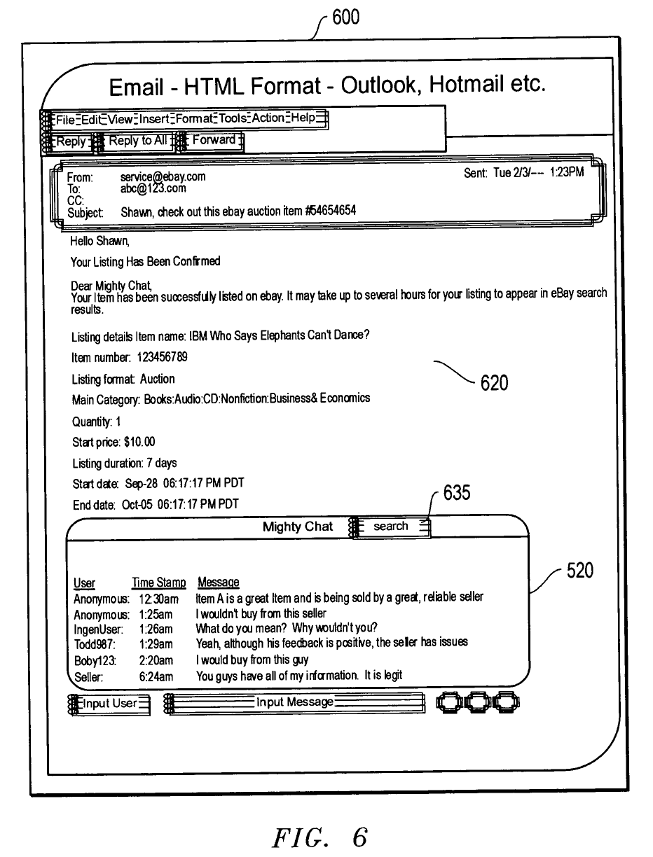

The MC system 1 facilitates an open forum method of collaborative communications, with or without, the typical constraints of user identification (“Ids”), log-ins, special software controls or equipment by using open standards such as, but not limited to, Web Services and XML. Advantages of the system 1 of the present invention include, but are not limited to, the following:
a. Users do not have to register on a site, or log into a MC chat room. Existing sites may require registration or make it mandatory and use their existing authentication system before participating in chats;
b. Visitors can use a MC chat box of the present invention and remain anonymous, without registering on a host site;
c. Visitors can open, use and hold a MC chat box according to the present invention while browsing the entire host site by referencing the identifying chat box on the site (as described in FIG. 5);
d. Visitors can receive the MC chat box of the present invention through email and have the ability to respond without going to the website. More specifically, since the chat box of the present invention can be embedded in HTML, email clients, such as Outlook, can render the chat box within an email and allow messaging functionality on any website that has the chat box embedded in it (as described in FIG. 6);
e. No special plug-ins are needed for the HTML version. A client may be rendered using any technology that can communicate via XML. (Java Applet, Macromedia Flash, Active X Control) For example, Macromedia Flash may be used to render the chat box if certain sites limit the use of certain HTML tags. MC comprises of standard JavaScript, HTML and XML languages;
f. Downloads are not necessary to utilize the present invention. Users need only open a MC system 1 chat box according to the present invention and enter their desired messages. The MC HTML code is self containing such that the code permits a user to save the code to a hard drive and then open it immediately and begin chatting. The code automatically opens in a default browser having a chat box as described herein;
g. The MC system 1 of the present invention can be configured to recognize emoticons in the messaging stream. An emoticon (or smiley face) is a sequence of ordinary characters found on a standard computer keyboard and when combined provide various emotions. Emoticons are used in e-mail, chat, SMS and other forms of communication using computers;
h. Host chat providers can setup an “undesirable word” dictionary to exclude from messages;
i. When users type in URLs and email addresses, the system automatically establishes a hot link; and
j. The present invention's MC chat boxes are customizable to match a provider's site design, presentation, and look and feel.

The MC system 1 comprises unique hosting software components that include HTML having encrypted data for uniquely identifying the chat box. These components reside on the host chat provider's server (not shown). The host chat provider configures the variable features of MC system 1 to fit specific host Web site operations. The host chat provider also may select where the collaboration database 15 is to reside, whether it be on the host chat provider's server (not shown) or on the MC central server (not shown).

The present invention implements the following methods to provide the functions of the messaging system. The MC system 1 authenticates by user identification, product identification, and consortium identification, chat room identification, or any other keyword or identifier specified in the host chat provider's custom profile. However, in one embodiment, MC 1 allows the user to remain anonymous and does not require authentication. For example, if the user enters a message and does not enter a username, the message is submitted anonymously. In the MC system 1, the hosting site (host chat provider) connects with remote sites for real-time communications and monitors communications, wherein at least one block of chat data is received from the user. Specifically, one block of chat data refers to the text that is entered in the text box within the chat box and subsequently submitted to the MC 1 server(s). Once the user presses the enter button, the text in the message text box is cleared to inform the user that the data was successfully submitted.

MC 1 then generates, by packaging the data in XML programmatically, an XML file from chat to the Common Application Program Interface CAPI 105 service where the XML is parsed and processed. The MC 1 chat box remains active twenty four hours a day/seven days a week to send and receive messages on demand. Messages transmitted by a sender remain available on the chat server for an intended recipient to retrieve at will. For example, users can simply view historical messages by logging into the MC system 1 site.

Users enter and submit a message, which sends an XML based packet using HTTP as the transport mechanism. This is done programmatically by packaging messages in XML format and posting them over HTTP to the CAPI 105 service. This is analogous to requesting a website in a browser. MC then receives the message at the processing server and identifies request by Site-specific identifier, listing specific identifier, user specific identifier (described in detail below). The message is processed by a cluster of MC 1 relational databases 15 and is uniquely identified by Site id (e.g. eBay, Yahoo), Listing Id (chat id or item # e.g. 34838383), and/or User Id (Seller, eBay seller or individual on website). An optional registration message may be sent to the remote server, comprised of a username, hostname, server name, and other data elements described in host server's custom parameters.

Through the use of the MC system's 1 CAPI 105 service, chat data is captured and stored by the process described herein. The CAPI 105 service is identified by a secure URL within the MC HTML. For example, the secure URL would be requested from an embedded MC chat box in a host website such as eBay. Once the user opens a webpage with the MC chat box embedded therein, the MC box queries the CAPI 105 URL with a request to get all chat messages for the specific site (such as eBay), User (Seller), and Listing ID or Chat ID number. Chat data is captured and stored by the following process:
(a) upon setup, host chat providers select the option of using their database server or the MC central server for data storage and manipulation;
(b) transcripts are captured and stored by user identification, product identification, consortium identification, chat room identification or any other keyword or identifier specified in the host chat provider's custom profile;
(c) transcripts are stored by none of the criterion contained in (b) above, in which case, messages are marked “anonymous”;
(d) subsequent to collaboration database storage, chat data is reformatted for queries and management reporting purposes;
(e) querying the collaboration database for occurrences of assigned keywords or alphanumeric identifiers, which are relational to the host chat provider's target databases and/or applications;
(f) chat data is manipulated by identifiers according to the host chat provider's custom profile;
(g) chat data is translated and exported to target application database(s) according to identifiers specified and business rules listed in the host chat provider's custom profile; and
(h) reports are generated from the collaboration database as specified by business rules listed in the host chat provider's custom profile, or generated by standard reporting tools as needed.

The features of the MC system 1 includes, but is not limited to, flexibility, scalability, compatibility, interoperability and the ability to interact with other applications through the CAPI 105 interface. The CAPI interface 105 of the present invention is exposed as a web service 130 and allows a plurality of external programs to communicate with the MC internal database via XML over HTTP. CAPI 105 renders a web service definition language (“WSDL”) for host providers to create special programs that translate, re-index and export transcripts to target application databases. WSDL is a standard format for describing a web service. Expressed in XML, a WSDL definition describes how to access a web service and what operations it will perform. WSDL is seen as one of the three foundation standards of web services. More specifically, it is a web services description language which identifies how external programs can communicate and use the exposed functionality provided by the CAPI. The special programs created by host providers permit services to be created to automatically pull or push messages as needed using XML over HTTP.

The present invention services multiple types of industries and various applications in the Internet universe. The MC system 1 is applicable in many industry sectors, including, but not limited to: Manufacturing, Professional Services, Healthcare, Research and Development, Transportation, Capital Goods, Stock Exchange, Commodities Trading, Energy, Electronic Commerce, Supply Chain, and Education. Any operation that can use messaging is a candidate for MC.

MC relates and communicates to multiple applications by using public application programming interfaces provided by third parties 60 such as, but not limited to, MSN, AOL, ICQ, and Yahoo. The MC system 1 allows the user to push and pull messages to Instant messengers without having to physically install them on the Internet, thereby allowing users to conduct collaborative conversations through instant messaging services. The present invention accommodates any situation requiring the exchange, capture, storing and manipulation of chat data for an online item or service. The MC system 1 provides a non-constraining, non-intrusive, and customizable host website (“host chat provides site”, not shown) capabilities by the host web site (“host chat provider's site”, not shown). More specifically, no programming is required for the host website to implement the present MC system 1 invention into their website.

Furthermore, conversations or messages may persist in a collaboration chat database 15, database cluster (not shown), or database grid (not shown) located either on a host chat provider's server (not shown) or an MC system 1 central server (not shown). For example, if a company desired to use the MC system 1 internally, the company would provide its own database to run the present invention internally. Such configuration would allow host chat providers the option to forego use of their resources, but still enjoy access and use of their historical chat files on the MC system 1 server. User/customer candidates may include, but are not limited to, enterprise providers and customers, suppliers, buyers and sellers, or any combination of co-beneficiaries who have a need to create, maintain and extend the use of electronic transcripts in a myriad of applications.

The MC system 1 combines instant chat and database technologies. Today, instant messengers save messages in text files which are not searchable in a standard format. By saving messages in a database, it allows archiving and searching using common database functionality. According to the present invention, the MC system 1 monitors the content of chat sessions via a collaboration manager component (not shown) and archives then via a collaboration archive manager component (not shown) and makes this data available for subsequent analysis and distribution by storing in the chat database 15. The CAPI 105 comprises each of these manager components.

Thereafter, all saved messages are made available for download in XML format and accessible from MC's 1 reporting system (not shown). MC 1 provides enhanced services capabilities to e-commerce, dating service sites, job posting sites, event notification sites, supply-chain and other business applications by allowing users to review and/or parse collected information at a later time while also allowing the users to strictly focus on the content of the communication during a specific chat session. Therefore, MC 1 salvages and makes use of transcripts that would have otherwise been discarded.

Considering the surge of new techniques and mobile wireless devices for capturing text, MC 1 is designed to complete the process. For example, Hewlett-Packard's “CapShare” and Siemen's “Pocket Reader, LLC,” are small, lightweight, mobile text-capturing devices that interface with multiple computer platforms. But these devices stop short of interfacing with the Internet and depositing captured data in a manipulative database. MC 1 extends the functionality by accepting text from a local server, then transporting it to a host chat provider's site and writing to a collaboration database. These devices allow exchange of data with MC 1 by downloading an XML based plug-in that allows the translation of data via XML over HTTP to MC 1 Web services 130.

The MC system 1 is configurable to eliminate the issue of online versus offline message conversants. Users do not have to be online to receive messages, provided there is a server-to-server connection, messages are posted, transmitted and stored on the host server. Further, users do not have to log into MC chat boxes, which can be embedded throughout the host chat provider's entire site or embedded in email messages. Utilizing the present invention, administration users have the ability to specify from an administration screen whether or not users wanting to post a message are required to login.

Users access a host chat provider's web site through normal Internet connections (via MC's server), including commercial online services and ISPs via devices including, but not limited to, desktop computers 10, personal digital assistants (PDAs) 20, laptop computers 35, tablet computers 40, and other devices indicated by reference numeral 50 in FIG. 1. Using normal web links, MC 1 allows visitors to instantly post and transmit messages to MC 1 collaboration chat database 15 or if it's managed by a host site, then to their database server. MC 1 allows for a website to provide functionality to manage database servers and users in house.

The MC system 1 maintains a historical collaboration database 15 of chat transcripts, searchable by keywords or key identifiers. Using SQL, the language of all databases, MC provides online reports and ad-hoc interfaces to query the chat transcripts. Through the use of the CAPI 105 package and its WSDL schema, transcripts can be automatically exported to other databases or existing applications. The MC system 1 can be interfaced with multiple applications, including Contact Management, Trading, Call Center Management, Professional Services, Customer Relations Management, Parts and Service Centers, Electronic Commerce, Supply Chain, and Association Management.

MC 1 is a unified messaging system, designed for horizontal, cross-industry and cross-demographic use. Unlike existing messaging systems, such as MSN IM, Yahoo, and AOL Messenger, MC exchanges messages using open industry standard protocol, SOAP, XML and HTTP between the host server and remote servers, and stores text strings either on MC's 1 central host server (not shown) which are initiated by an HTTP request to the open XML based CAPI service. Once this request is received, programming logic parses the incoming XML data packet and appropriately parses necessary data elements that describe the site, user, chat id and then inserts the data into the database 15 or the host chat provider's collaboration database (not shown).

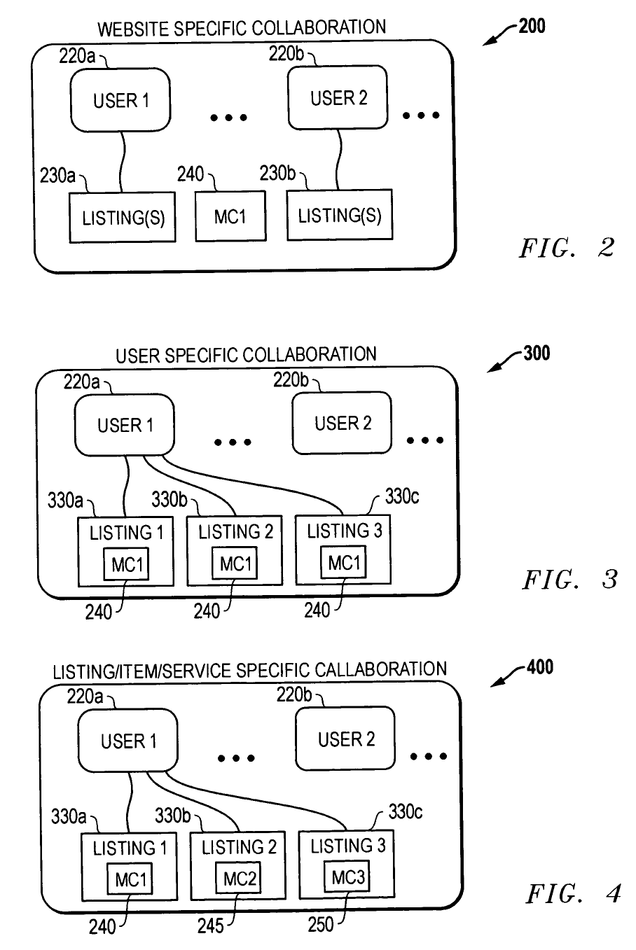

According to the host chat provider's parameters, users do not need a login name, but can use the host providers user authentication system, if desired. Users can also be associated with generic or specific “chat rooms.” As shown in FIGS. 2 through 4, this is accomplished by distributing different encrypted tags that can make the “chat room” website specific, user specific, or listing/chat specific.

For example, FIG. 2 depicts how the one instance (MC1) 240 of the present invention is used within one specific website (herein termed—site specific collaboration 200) for all users 220a, 220b, . . . and all product and service listings 230a, 230b. One example is wherein one embedded instance of MC1 240 is used within a website. Such a situation which would allow every visitor that browses every webpage on that site to view the same conversations or messages entered. It must be understood by one skilled in the art that the amount of users greater than one is unlimited.

FIG. 3 depicts how the present invention is also used within only one website, but where it is specific to a particular user 220a, 220b, . . . , (herein termed—user specific collaboration 300). However, unlike in FIG. 2 wherein only one instance of the invention is embedded in within a website, FIG. 3 provides the ability for one user 220a, 220b, . . . to insert at least one embedded instance MC1 240 of the invention in all desired auction listings such as listing-1 330a, listing-2 330b and listing-3 330c on the website (e.g., eBay).

FIG. 4 depicts how the present invention is used within only one website but specific to a user 220a, 220b, . . . and unique to an auction or listing such as listing-1 330a, listing-2 330b and listing-3 330c (herein termed—item/service specific collaboration 400). Utilizing the present invention within a particular auction or listing allows for embedding of an instance of the invention MC1 240 in Listing-1 330a, an second instance MC2 245 within listing-2 330b, and a third instance MC3 250 in listing-3 330c to be specific to that particular auction.

One example of a benefit offered by MC 1 relates to auction sites wherein there exists a growing problem relating specifically to fraudulent sellers or shill bidding. Shill bidders work together with sellers to artificially raise the price of auction items they have no intention of buying. With MC 1 embedded in an auction site (e.g., eBay) buyers may assist in helping prevent future fraudulent activites by providing instant feedback on a specific product or specific seller. Buyers can post messages to inform other potential buyers of either negative or positive aspects of a transaction. Conversely, sellers can resolve disputes and salvage good will by posting answers or alternatives for regaining satisfaction. Existing auction sites like eBay are reactive, after the fact and extremely bureaucratic in their methods of handling fraud. Most claims on auction sites are introduced after thirty days, which gives an unfair advantage to frauds. In contrast, the MC system 1 provides real-time and proactive involvement, thereby encouraging users to provide instant feedback and continued interaction during the life of the auction or transaction. Instant feedback, data capture and analysis and historical archiving comprises a core benefit of fighting fraud on auction sites.

By having chat boxes embedded within web pages utilizing basic HTML tags, this allows processing using HTTP Post, XML, and Web service technologies. Specifically, MC 1 may be embedded into third party websites 60 via at least two methods. First, on a website, for example eBay, sellers embed MC manually by adding the HTML generated code from MC's site into their specific auction description. Once the HTML is inserted, the encrypted tags uniquely identify the host website (for example, eBay), the seller, and listing Id number. These tags are also used throughout MC's internal system to identify, query, and archive messages.

As shown in FIG. 5, MC 1 offers virtual messaging 520 on front-end Web pages 500 or embedded in email messages 600 (Shown in FIG. 6) and customized collaboration database operations on the host server's back-end systems (not shown). Specifically, MC HTML is inserted into, for example, eBay's auction HTML description using eBay's developer application programming interfaces. This embeds the chat box onto the auction site while referencing MC central database servers via XML and HTTP. Furthermore, the process captures and stores text messages in a relational database (not shown) for archiving or searching. As messages are entered by a user, the MC system 1 stores each message by date-time, Origination IP address, Referral IP address, User, Location, State and Country in the MC system's 1 central database server. Users may program against MC's 1 web services 130 and create individual custom programs or database operations. Using the unique CAPI 105 components, described above in relation to FIG. 1, MC 1 invokes a new method for real-time information gathering and management.

Chat rooms are customized groupings of conversants associated with the host chat provider's criterion of databases (i.e., products, suppliers, customers, consortiums, value chain networks, ordinary contacts, job postings, cars, dating sites, etc.). Generally, chat rooms can be assigned keywords or alphanumeric identifiers, and schemas that are interfaced to the host provider's selected databases and/or applications. For example, as shown in FIG. 5, an auction company can make a chat box 520 mandatory on its website 500 in all listings or offer the chat box 520 as a listing upgrade to generate more sales, wherein the seller's information 510 is placed within a specific page on the site. Using the chat box 520 comprising the MC system 1 of the present invention, users are able to communicate within the site 500 in a virtual real time mode and also provide input to review an existing item review 530 section on the site 500. Another example would be to use a chat box 520 in a dating service website, wherein the chat box 520 is embedded in the profile section for individual users. The individual searching for a date can post a question in the chat box and come back when it is convenient to read the response.

In reference to FIG. 6, an event notification service can send out event specific emails with the chat box 520 embedded in the email message 600. This allows users to respond without going to a particular website. Users need only sign-in with the hosting site and post a message in the chat box 520. When implemented, the MC system 1 dates and time-stamps the email message entered by the users and then displays the text on the screen for further editing. Once the user submits the message, MC 1 writes the message to the collaboration database 15 and transmits it to the recipient. The recipient does not have to be online for this to be accomplished. This is accomplished by presenting the same message in the chat box 520 for the user to review when online. Because MC 1 is configured to be event driven, it only transmits messages after messages are entered and transmitted by user. The chat box 520 is rendered only after an accompanying web page is opened in a browser or an email message 600 is opened in an email compliant program. Subsequently, users are able to retrieve information for reviewing, tracking, and printing and to continue the string of interactive communications. The time delay caused by the writing of the message 600 to the collaboration database 15 is not noticeable by the users.

In addition, a benefit of the MC system 1 of the present invention, Internet provider filtering is utilized to allow only certain Web sites to access MC. If the site is granted access to MC, then users within that Web site (eBay) will be able to enter messages. If a hacker copies the MC HTML code and tries to alter, manipulate, or insert random messages programmatically, MC security settings will block all processing from internet providers that are not approved by the system.

Once an email 600 has been received with the chat box 520 embedded therein, the same chat box 520 is then referenced in a hosting website (for example, eBay). Because two instances of the present invention can reference the same Site, User, and Chat Id, the MC system 1 groups and distinguishes messages regardless of their origination.

Referring now to FIGS. 5, 6 and 7 collectively, according to the present invention email messages 600 can be used to participate in chat discussions for specific chats, wherein an initial chat box 520 is setup on the host chat provider's server. An email message 600 is created and the email message 600 is sent to recipient users with the same chat box 520 that was imbedded within the body 620 of their email messages 600. The chat box 520 is sent as a regular HTML email message with HTML tags embedding the chat box 520 and calling a chat engine web service using Querystring technology, XML, HTML, and HTTP post. A search box 635 may be positioned on the chat box 520 to allow all users search capabilities within the chat box 520. This is accomplished by querying messages stored in the database 15 using SQL. Search results are then returned in the message box 520 for easy access. Only HTML compliant email programs, such as Outlook, will be able to view chat boxes 520 within the email 600. Email recipients can then respond within their email messages 600 and are not required to open website 500 pages to respond. This is made possible because the MC 1 chat box 520 processing is done remotely and not within the email 600. When a user submits the message from within the email 600, the message is packaged in XML and sent over HTTP to the CAPI 105 service.

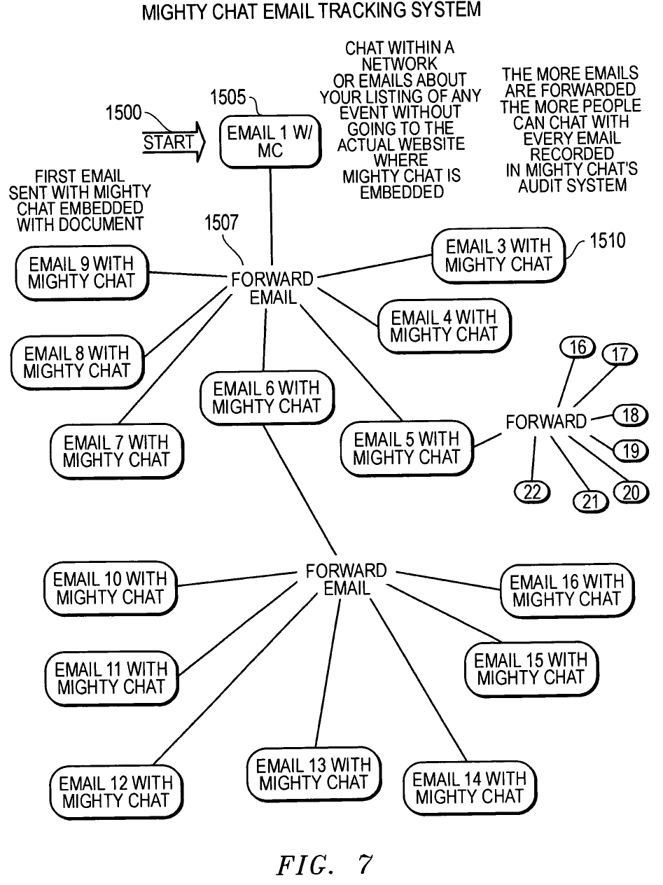

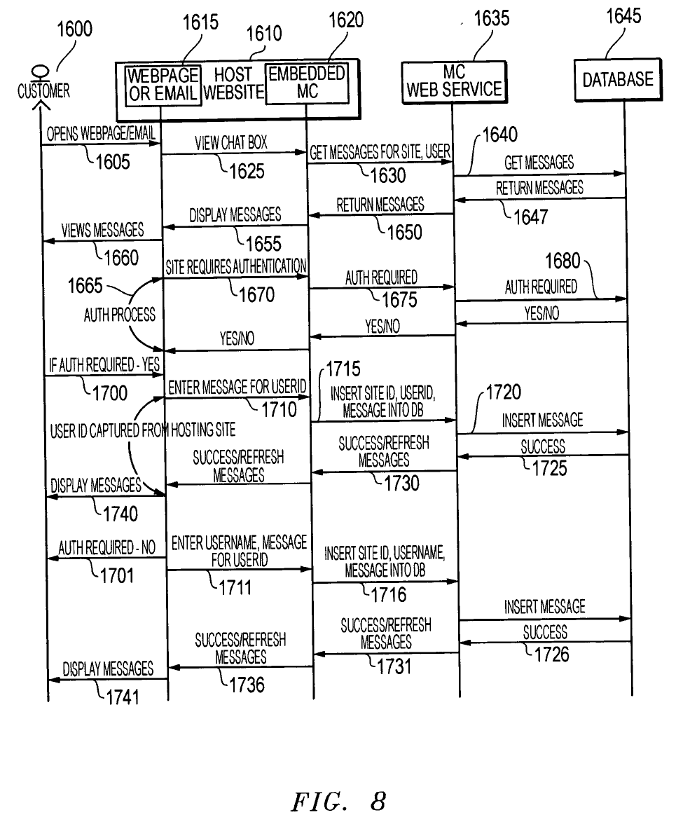

As specifically shown in FIG. 7, a recipient can forward an email 1507 with chat messages to one or more users to view that same chat-specific text. This allows a plurality of users to chat within a network of emails about a specific listing or any event without going to the actual website where the MC system 1 code is actually embedded. Further, the more forwarded emails 1507 the more people that will be available to chat within each forwarded email 1507 recorded in MC system's 1 audit system (not shown). For example, a user starts 1500 by sending a first email 1505 with MC code embedded in the document. Next, the first email 1505 is forwarded 1507 at least one time, or may be forwarded a plurality of times as shown in FIG. 7, which effectively creates other emails having MC code embedded therein 1510 to different users. By further reference to FIG. 7 it is readily apparent that the number of emails that can be forwarded which contain the MC embedded therein is virtually limitless. By doing this, email recipients can chat with others within the specific email that was forwarded, thereby creating a network of messages within a customized network of email addresses. Each forwarded email may be tracked by the (user) IP address and/or MAC address for auditing purposes, thereby allowing specific analyses to be done on a message or email data.

Now turning to FIG. 8, the present invention provides for a system that is a collaborative, authenticating or non-authenticating, embedded open forum communications environment. Specifically, the MC system 1 may be configured to require login before submitting messages and is done in two ways. First, the host provider's session is used to determine if a login was successful or not. The second is done using an MC embedded interface, wherein the chat box will require credentials that are stored on MC's servers to determine proper authentication, thereby allowing messages to be submitted. If the Web site requires authentication before messages are submitted, then MC can be configured to capture site users (eBay User Ids) before messages are transmitted and saved. Users are allowed to connect to a host chat provider's Web site or receive the same chat box in an email message and initiate extended chat conversations at will.

More specifically, FIG. 8 shows a data flow diagram according to an embodiment of the present invention shown detailing the actions taken and executed within the architecture of the present invention. Specifically, a customer 1600 opens a webpage/email 1605 within a host website 1610 and views 1625 the chat box containing embedded HTML code of MC 1620. The customer 1600 then executes a command to get messages for the site 1630 from the MC web service 1635. The messages are retrieved 1640 from the database 1645.

Upon retrieval from the database 1645 the messages are returned 1647 to the MC web service 1635. Thereafter the messages are then returned 1650 to the embedded MC 1620 and are displayed 1655 on the webpage/email 1615 of the host website 1610, wherein the host website 1610 executes an authentication process 1665 if the host website 1610 requires authentication 1670. The authentication determination process is conducted through the MC web service 1635 and through the database 1680. If authentication is required 1700, the embedded MC 1620 within the host website 1610 instructs a message to enter UserID 1710. The MC web service 1635 instructs a message to insert 1720 site ID, UserID, and message ID 1715 into the database 1645. If the authentication input information is correct and successful 1725 the messages are refreshed 1730 in the host website 1610 for display in the webpage/email 1615. If so, the messages are then displayed 1740 for viewing 1660 by the customer 1600.

However, if authentication in the website/email 1615 is not required 1701 the host website 1610, the embedded MC 1620 within the host website 1610 instructs the customer 1600 to enter UserName and message for UserId 1711. The MC web service 1635 instructs insertion of SiteID, UserName, and message 1716 into the database 1645. If successful 1726 the messages are then refreshed 1731 by the MC web service 1635 to the embedded MC 1620 within the host website 1610 and then refreshed 1736 to the webpage/email 1615 for display of the messages 1741 to enable the customer 1600 to view 1660 the messages.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. It is therefore, contemplated that the claims will cover any such modifications or embodiments that fall within the true scope of the invention.

1. A collaborative messaging system, the system comprising:
a network;
at least one microprocessor for facilitating the communication of information over the network;
a collaborative messaging programming interface in communication with the at least one microprocessor; and
a messaging database configured to store messages communicated by conversants via the interface.

2. The system of claim 1 wherein the network is connected to the at least one microprocessor via at least one third party website.

3. The system of claim 2 wherein the third party website is an auction site.

4. The system of claim 1 wherein the microprocessor is selected from the group consisting of a desktop computer, laptop computer, personal digital assist (PDAs), and computer tablets.

5. The system of claim 1 wherein the messaging programming interface is embedded in at least a host web page.

6. The system of claim 5 wherein the programming interface utilizes a programming language and device selected from the group consisting of HTML, XML and Macromedia Flash to capture, render and write data.

7. The system of claim 6 wherein the data is written and archived in a database.

8. The system of a claim 1 wherein the interface is embedded in at least an e-mail.

9. The system of claim 1 wherein the database is a collaboration messaging database.

10. The system of claim 1 wherein near real-time communications are achieved between at least two conversants.

11. The system of claim 1 wherein the conversants remain anonymous.

12. The system of claim 1 wherein the conversants' identification may be authenticated by selecting from the group consisting of user identification, product identification, chat room identifications, and any keyword/identifier specified by a host chat provider's site.

13. The system of claim 1 wherein the messaging programming interface generates an XML file from chat data for conducting internal processes.

14. The system of claim 5 wherein the programming interface is a collaboration application programming interface (CAPI).

15. The system of claim 14 wherein the CAPI comprises a collaboration manager, a collaboration archive manager, and a collaboration security manager.

16. The system of claim 14 wherein a web service comprises the CAPI and at least one database.

17. The system of claim 1 wherein the system comprises software provided on a host chat provider's website, wherein the software indexes at least one block of chat data.

18. The system of claim 17 wherein the indexing comprises extracting at least one parameter from the block of chat data, wherein the indexed block of chat data comprises a keyword on tag to identify a prescribed parameter.

19. The system of claim 16 wherein the web service is accessible via the Internet.

20. A method for messaging and collaboration within a system, the method comprising the steps of:
connecting with an MC system server;
identifying a unique chat using Querystring technology; and
using XML packaging over HTTP to enable conversants to exchange messages in near real time, wherein the conversants need not be online to receive the message.

21. The method of claim 20 wherein the system remains active to send and receive messages on demand.

22. The method of claim 21 wherein messages transmitted by a user remain available on a server for its intended recipient to retrieve at will.

23. The method of claim 20 wherein the step of opening a communication session comprises the steps of:
a) opening a chat interface on at least a host chat provider's server;
b) sending a request to check site, user and chat ID for security and message availability;
c) receiving unique messages within the chat interface from an MC server after authorization and authentication of user and site;
d) sending a unique message via XML over HTTP to an identifiable MC server;
e) based upon the responses in steps a), b), c), and d), sending a command to a remote server requesting product identification, consortium identification, chat room identifications, and a host chat provider's custom profile.

24. The system as in claim 20 wherein the conversants remain anonymous.

25. A method for capturing and storing chat data, the method comprising the steps of:
a) providing an interface tool;
b) selecting a server for data storage and manipulation, wherein the decision is made by the host chat provider;
c) capturing and storing transcripts in a database; and
d) reformatting the chat data.

26. The method of claim 25 wherein step (b) the server selected is a host chat provider's database server comprising a database cluster and/or a database grid.

27. The method of claim 25 wherein step (b) the server selected is a central server.

28. The method of claim 25 wherein step (c) the transcripts are captured and stored by identification selected from the group consisting of user identification product identification, consortium identification, and chat room identifications.

29. The method of claim 25 wherein the database is a message collaboration database.

30. The method of claim 25 further comprising the steps of:
querying the database for relational keywords or identifiers;
manipulating chat data by identifiers according to a host chat provider's custom profile;
translating and exporting chat data to target application databases; and
generating reports from the database information.

31. A method for conducting website specific collaborations, the method comprising the steps of:
proving a host website;
generating customized HTML code for conducting collaboration between at least two conversants on the website.
providing at least one user having at least one listing specific to that user; and
embedding the HTML code on the website.

32. A method for conducting user specific collaborations, the method comprising the steps of:
providing a host web site;
generating customized HTML code for conducting collaborations between at least two conversants on the website, wherein the code is embedded in a plurality of listings on the website specific to a user.

33. A method for conducting listing specific collaborations, the method comprising the steps of:
providing a host website;
generating customized HTML code for conducting collaborations between at least two conversants on the website, wherein the code is unique to a specific user having a specific listing, wherein the user can have a plurality of listings.
